(19) United States
(12) Patent Application Publication
(10) Pub. No.: US 2020/0094575 A1
(43) Pub. Date: Mar. 26, 2020

(54) TWO-STAGE DENSITY COMPENSATION METHOD

(71) Applicant: HEIDELBERGER DRUCKMASCHINEN AG, HEIDELBERG (DE)

(72) Inventors: AXEL HAUCK, KARLSRUHE (DE); ILIAS TRACHANAS, PLANKSTADT (DE); BERND STRITZEL, GOOSEFELD (DE); FLORIAN KLOEPPNER, KIEL (DE)

(21) Appl. No.: 16/580,588

(22) Filed: Sep. 24, 2019

(30) Foreign Application Priority Data
Sep. 26, 2018 (DE) 10 2018 216 430.4

(51) Int. Cl. B41J 2/21

(52) U.S. Cl. CPC B41J 2/2103

(57) ABSTRACT

A computer-assisted method for compensating for position-dependent density fluctuations in printing nozzles of inkjet printing heads in an inkjet printing machine includes implementing pre-compensation for all color separations of a print image during the halftoning process in the pre-print department on the basis of a pre-defined density compensation profile by using a pre-print computer. Online compensation is implemented for all color separations of the now pre-compensated print image during an on-going production run for producing the print image on the basis of a re-calculated density compensation profile by using a control unit of the inkjet printing machine.

### CROSS-REFERENCE TO RELATED APPLICATION

This application claims the priority, under 35 U.S.C. § 119, of German Patent Application DE 10 2018 216 430.4, filed Sep. 26, 2018; the prior application is herewith incorporated by reference in its entirety.

### BACKGROUND OF THE INVENTION

### Field of the Invention

The invention relates to a method for compensating for density irregularities in a direction transverse to the printing direction in an inkjet printing machine.

The technical field of the invention is the field of inkjet printing.

In the field of printing, an important quality feature is to obtain an unequivocal, clearly defined reproduction of the image content. The reproduction ought to have the same result at all locations within the printable format, an aspect that requires local homogeneity of the print. Digital printing is faced with the challenge of ensuring the required homogeneity in a direction transverse to the printing direction (x-track). In general, inkjet printing heads exhibit a certain amount of variation in the jetting behavior of individual nozzles, a variation that is caused by inaccuracies in terms of manufacturing and ink supply to the nozzles, mechanical inaccuracies of the piezoelectric actuators, etc. All these potential inaccuracies result in density/coloration inhomogeneity across the printing head despite an identical actuation of the printing nozzles.

That problem is solved with the aid of density compensation methods. Density inhomogeneity despite a uniform actuation of all nozzles is recorded by using test charts for a specified number of area coverages. Based on the gradients in a direction transverse to the printing direction, compensation profiles are determined and made available in the printing operation to obtain a homogenous reproduction.

Two different approaches have become known and are used in existing printing systems as solutions to that problem.

1. Compensation by location-dependent calibration in the haltoning process:

In that case, the halftones are formed of 4096 different patterns; the number 0 pattern is a completely white area and the number 4095 pattern is a completely black area. The stages between those values form tone value steps and are monotonically increasing. If no calibration is used, the 256 input values are represented by the 4096 patterns in the following way:

gray value 0−>pattern 0, gray value 1−>pattern 16, . . . gray value 255−>pattern 4095.

A modification of the mapping rule may be used for calibration purposes (steps no longer equidistant) and to set an ink limit (the pattern for gray value 255 is smaller than 4095). That method has been well-established for a long time and is used in a wide variety of halftoning processes.

In order to provide density compensation on the basis of that method, the position within the row is taken into consideration for the mapping rule. For that purpose, the density profile and calibration are used to calculate a look-up table (LUT) that contains the number of the halftone pattern to be used for every position in the row/gray value combination. That halftone pattern is then used in the halftoning process.

### Advantages of the Method

The mapping characteristics of the halftone are preserved; in particular, it has no negative effect on graininess, noise, gradients, etc. The area coverage required for the calculation is known at a high resolution from the image content and does not need to be determined expressly for the purpose like in the second method.

### Disadvantages of the Method

Compensation is implemented in the halftoning process, i.e. modifications to the compensation profile require a new halftoning process, which is relatively time-consuming and can only to a limited extent be done online. A shift of the print in a direction transverse to the printing direction, i.e. relative to the printing units, also requires a new halftoning process. Conversely, once the halftoning process has been completed, modifications to the transverse register or to the position of the sheet/web in the machine transverse to the printing direction are virtually no longer possible because they cause the local compensation parameters to shift relative to the printing heads together with the image and are thus no longer correctly allocated.

2. Compensation in the Individual Color Separation Halftones That Have Been Created (Online Compensation):

In accordance with that method, density compensation is achieved on the basis of the color separation halftone. The first step is to determine the area coverage of the location to be compensated for in the image on the basis of the halftone. That is not achieved in high resolution on the basis of the image information but by using a matrix, such as a window across 3×9 pixels across the entire halftone, i.e. by averaging a number of halftone dots. Then the area coverage is used to calculate the associated compensation profile/the local value by interpolation, and the pixel values, distribution, and ink volume are adapted in a suitable way to obtain the image target value. That is done online in the course of an ongoing printing operation by using the control unit of the inkjet printing machine. The increase or decrease of the image values is done by setting or eliminating dots or by increasing or decreasing the dot size through the jetted drop volume.

### Advantages of the Method

That compensation process is done online and may be done very quickly because it is done on the fly and does not require the printing operation to be stopped. The image may be shifted relative to the printing heads without any problems, for instance when the register is modified.

### Disadvantages of the Method

Determining the local area coverage using a sliding window in combination with the method may result in artifacts at the margins of areas or in the case of line elements.

Interfering with the halftone image due to the corrective measures changes the halftone. That may have a negative effect and may in fact create undesired structures, graininess, noise, or other artifacts, especially when major corrections are made. The halftone algorithm is generally optimized in terms of image characteristics such as homogeneity, resolution, smoothness, robustness, etc. Interfering with the configuration of the halftone may result in loss of quality.

Another problem that occurs in inkjet printing is the presence of so-called white lines, which are strip-like artifacts in the printing direction caused by a malfunctioning or even failure of individual printing nozzles. There are separate approaches to compensating for such defects. Those approaches may likewise be implemented on the fly in the halftone image during an ongoing printing operation in addition to density unevenness compensation. A localized accumulation of white lines that need to be compensated for makes density compensation especially difficult; in such a case, visually perceivable inhomogeneities may persist. Thus, white line compensation also has an influence on density fluctuation compensation. Therefore, the method for compensating for local density fluctuations needs to factor in the white lines that have occurred and the measures to compensate for them.

### SUMMARY OF THE INVENTION

It is accordingly an object of the invention to provide a method for compensating for density fluctuations in inkjet printing heads in an inkjet printing machine, which overcomes the hereinafore-mentioned disadvantages of the heretofore-known methods of this general type and which combines the advantages of methods known for this purpose without combining the corresponding disadvantages.

With the foregoing and other objects in view there is provided, in accordance with the invention, a computer-assisted method for compensating for position-dependent density fluctuations in printing nozzles of inkjet printing heads in an inkjet printing machine, comprising the steps of implementing pre-compensation for all color separations of a print image during the halftoning process in the pre-print department on the basis of a pre-defined density compensation profile by using a pre-print computer, and implementing online compensation for all color separations of the now pre-compensated print image during an on-going production run for producing the print image on the basis of a re-calculated density compensation profile by using a control unit of the inkjet printing machine.

In order to benefit from the advantages of both methods in a corresponding way, the two methods are combined and adapted, The adaptation is formed of executing the first known compensation method during the halftoning process by adapting the calibration as a first step to achieve a type of pre-compensation. This step of pre-compensating for the occurring position-dependent density fluctuations in the printing nozzles of the inkjet printing heads allows the majority of these deviations in the print behaviors of the printing nozzles to be eliminated. If further problems in terms of printing nozzle density fluctuations occur during the printing operation, they are compensated for in the course of an online compensation process by using the second known prior art method of compensating for the occurring density fluctuations by adapting dots or rather dot sizes of the ink drops applied during the printing operation on the basis of an analysis of the local area coverage. For this purpose, it is clearly necessary to obtain test prints at regular intervals to find newly occurring density fluctuations. Since the majority of density fluctuations has been eliminated in the course of the pre-compensation process, fewer adaptations need to be made in the course of an online compensation than if only the online compensation method was used. Therefore, the disadvantage of this online compensation method, namely the fact that interfering with the existing halftone of the print image that has already been created when the printing operation takes place causes artifacts, is in fact avoided. Due to the fact that the corresponding print image to be created is submitted to the halftoning process only once and no further halftoning process involving a correspondingly adapted calibration is carried out, the disadvantage of the first known method of the prior art, namely the fact that a time-consuming and complex halftoning process needs to be carried out again to be able to compensate for density fluctuations that occur during the printing operation, is avoided. The combination of both methods as proposed by the invention thus provides efficient compensation of the occurring position-dependent density fluctuation in the printing nozzles, making use of the advantages of both methods while avoiding the disadvantages as much as possible.

Advantageous and thus preferred further developments of the method will become apparent from the associated dependent claims and from the description together with the associated drawings.

Another preferred development of the method of the invention in this context is that the pre-defined density compensation profile for the pre-compensation process is created by using test measurements and/or on the basis of the density inhomongeneities that have been documented by the printing head manufacturer whereas the newly calculated density compensation profile for online compensation is calculated by the control unit of the inkjet printing machine on the basis of a comparison between existing target values and measured actual values of an area coverage of all color separations. Both compensation processes require a corresponding density compensation profile. This compensation profile indicates the printing nozzles of the inkjet printing heads in the inkjet printing machine that need to print more or less ink to compensate for the density fluctuations inherent in the respective printing nozzle, and how much more or less ink they need to apply. Thus, the compensation profile is always in the form of a position-dependent function determining the amplitude, i.e. the jetted amount of ink, of every single printing nozzle. Since the pre-compensation is the first step and is formed of an adaptation of the calibration of the halftoning process at the pre-print stage, at this point the compensation profile(s) required for this purpose need to already be available on the computer. It/they may be created by test measurements that are taken prior to the printing operation to detect density fluctuations of the individual printing nozzles in the first place and to create a compensation profile that matches the detected density fluctuations. Alternatively, it is possible to use the compensation profiles that have been provided “ex factory” by the manufacturer of the inkjet printing heads. The process that is chosen depends on the conditions of the printing operation, the inkjet printing machine that is used, and the experience of the operator. Another conceivable way to proceed is to start with the compensation profiles provided by the printing head manufacturer and to update them with further test measurements. For the second part of the method, which refers to online compensation carried out during an ongoing printing operation, in addition or as an alternative to the test measurements, it seems expedient to use the printed products created during the printing operation as the starting point for measurements of the area coverage that has been achieved. Similar to the test measurements for the pre-compensation process, these values may then be used to calculate a current compensation profile or current compensation profiles. It goes without saying that this is required for all existing printing heads of all color separations, i.e. of all inking units.

A further preferred development of the method of the invention in this context is that upon a register change in a direction transverse to the printing direction, the density compensation profile calculated by the control unit of the inkjet printing machine is corrected by the control unit by subtracting the delta of the register change between the original predefined density compensation profile and the pre-defined density compensation profile that has shifted due to the register change from the calculated density compensation profile. If a register change is made while the printing operation is being carried out, this register change needs to be factored in when the compensation profile is calculated during online compensation. Otherwise the position-dependent compensation values for every single printing nozzle in the compensation profile would no longer be used for the printing nozzles that they are actually intended for, but for a neighboring printing nozzle. In order to avoid that, the delta of the register change is subtracted in a corresponding way.

An added preferred development of the method of the invention in this context is that the pre-compensation process mainly corrects printing head-dependent density inhomogeneities whereas the online compensation process preferably corrects printing substrate influences. In accordance with the status of the printing operation, each one of the two compensatory steps of the compensation preferably corrects the disturbing influences that predominate at this point of the printing operation, In the pre-compensation step, the predominant influences are the printing head-dependent inhomogeneities, i.e. the density fluctuations that are known from the data provided by the printing head manufacturing company—which may even provide a compensation profile derived from these data in the first place. When the printing head-dependent inhomogeneities have been corrected by the pre-compensation process, the online compensation process will only result in minor changes. The online compensation mainly focuses on substrate influences.

An additional preferred development of the method of the invention in this context is that for the online compensation process, the control unit of the inkjet printing machine factors in the influences of different halftones in the pre-compensation process. The two compensatory steps of the method of the invention are thus not completely independent of one another. It goes without saying that the influences of different halftones in the pre-compensation process to eliminate the density fluctuations/inhomogeneities are dependent on the type of the halftones that are used in the halftoning process. Since these halftones are applied when the actual printing operation is carried out as the print image halftone is printed by the inkjet printing machine, it makes sense to take them into consideration as an influencing factor for the online compensation process. Yet this does not mean that another halftoning process is required or carried out during the online compensation process.

Another preferred development of the method of the invention in this context is that during the pre-compensation process, in the course of the calibration of the raster image processor, a look-up table is used to assign specific halftone patterns to specific gray values of the print image color separations that are to undergo the halftoning process, the look-up table containing the position of every printing nozzle of the printing heads of the inkjet printing machine as an additional variable, wherein for every position of a printing nozzle, the pre-print computer enters a complete set of gray values with associated adapted halftone patterns into the look-up table, wherein the pre-print computer uses the halftone patterns in the print image halftoning process, and wherein the pre-compensated halftone print image is printed by the inkjet printing machine. The pre-compensation process thus uses the known compensatory method applied during the halftoning process. It is based on the fact that the halftones that are used in the halftoning process need to be calibrated anyway. Instead of using a look-up table assigning a specific halftone pattern to every gray value in the halftoning process as it has been known so far, the halftoning process additionally receives information on the position of every printing nozzle. In this way, the calibration process, i.e. the process of assigning a specific gray value to a specific halftone pattern, may be made a function of the performance of the respective printing nozzle. If a printing nozzle prints a little less ink than expected, for instance, and if the amount of ink that is applied needs to be increased in the course of the density compensation process, a halftone with a correspondingly increased amount of ink may be assigned to the printing nozzle in question to compensate for the effect of the density fluctuation. Thus, the calibration process, which is necessary in any case, is simultaneously used to compensate for local density fluctuations. It goes without saying that the density fluctuations of the individual printing nozzles need to be known prior to the calibration process. For this purpose, density fluctuation measurements need to be taken in advance. However, since the density compensation process needs to be carried out continuously, the current density fluctuation values of the individual printing nozzles continuously need to be detected at regular intervals anyway. The introduction of the position of every printing nozzle as a potential parameter in the look-up table additionally causes the look-up table to be expanded to form a matrix. Thus, there is no longer a single look-up table assigning a specific halftone to every gray value. Instead, there are n look-up tables, with n being a function of the number of positions used for every printing nozzle.

A further preferred development of the method of the invention in this context is that for every position of a printing nozzle in the look-up table, the adapted assignment of halftone patterns to gray values is a function of the density fluctuation of the respective printing nozzle. The adapted association ensures that the calibration of the halftone may already efficiently compensate for the local density fluctuation exhibited by every printing nozzle. For instance, if the amount of ink jetted by a corresponding nozzle is too small and results in a color value that is too low in the printed image, an adapted assignment of the halftone to the desired gray value may compensate for this density fluctuation. Since the density fluctuation, in this case a color value that is too low, is already known when the calibration process takes place, a higher halftone value than would normally be the case is used for this printing nozzle, i.e. for this position to compensate for the hypofunction of the printing nozzle in a corresponding way.

An added preferred development of the method of the invention in this context is that a maximum ink limit is implemented in that the pre-print computer assigns lower halftone patterns to higher gray values than it would in an equidistant normal distribution. In inkjet printing, there are so-called maximum ink limits because in contrast to lithographic offset printing, color separations cannot be printed on top of one another without any limitation. Too much ink in a specific location on the printing substrate has a negative effect, for instance in terms of the drying behavior or the condition of the printing substrate. Limiting the maximum amount in the course of the calibration is easy, Instead of assigning higher halftone patterns with a very high ink volume, e.g. a maximum value of 4095, to higher gray values such as the highest gray value 255, a different approach is chosen in this case, A value of 4095 would result in such a high volume of ink that the maximum ink limit would already be exceeded, Thus, in the course of the calibration, higher gray values are not assigned the higher halftone pattern that would correspond to equidistant steps in a conversion of 8-bit gray values to 12-bit halftone patterns, but a halftone pattern of a correspondingly lower order. For a gray value of 255, for instance, a number 3172 halftone pattern would be entirely sufficient. An important aspect in this context is that the reduction of the distance that is thus required between the individual halftones that are assigned to the rising gray values in a corresponding way is carried out in such a way that color fidelity, i,e. the target color values of the corresponding print job, is guaranteed.

An additional preferred development of the method of the invention in this context is that during the online compensation process, the control unit determines the actual area coverage for the location in the print to be compensated for on the basis of the halftone by using a matrix, calculates the associated density compensation profile, and adapts the print image data in such a way that the area coverage target values are attained. It has been found to be advantageous if the actual area coverage for the location to be compensated for in the image is determined first on the basis of the halftone. This is not done in high resolution on the basis of the image information but calculated by using a matrix such as windows across 3×9 pixels across the halftone image, i.e. by averaging a number of halftone dots. The area coverage is then used to calculate the associated compensation profile/the local value by interpolation and the pixel values, distribution and volume are adapted in a way suitable to obtain the target image value.

Another preferred development of the method of the invention in this context is that the control unit adapts the print image data by setting/eliminating pixels or by increasing/decreasing pixel sizes by controlling the jetted ink drop volume. This is the preferred approach to the necessary adaptation of the increase or decrease of the image values of the print image data.

A concomitant preferred development of the method of the invention in this context is that systematic density fluctuations that occur during the online compensation process are eliminated in a following print job by the pre-compensation process. This naturally only concerns density fluctuations that are not directly dependent on the print job. In addition, a data connection is required between the inkjet printing machine control unit executing the online compensation process and the pre-print computer to make the required data available to the pre-print computer for the purpose of the pre-compensation process.

Other features which are considered as characteristic for the invention are set forth in the appended claims.

The invention as such as well as further developments of the invention that are advantageous in structural and/or functional terms will be described in more detail below with reference to the associated drawings and based on at least one preferred exemplary embodiment.

Although the invention is illustrated and described herein as embodied in a two-stage density compensation method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram illustrating an example of the structure of an inkjet printing machine system;

FIG. 2 is a diagram illustrating an example of a halftoning process with calibration and density compensation; and

FIG. 3 is a flow chart of the method of the invention.

### DETAILED DESCRIPTION OF THE INVENTION

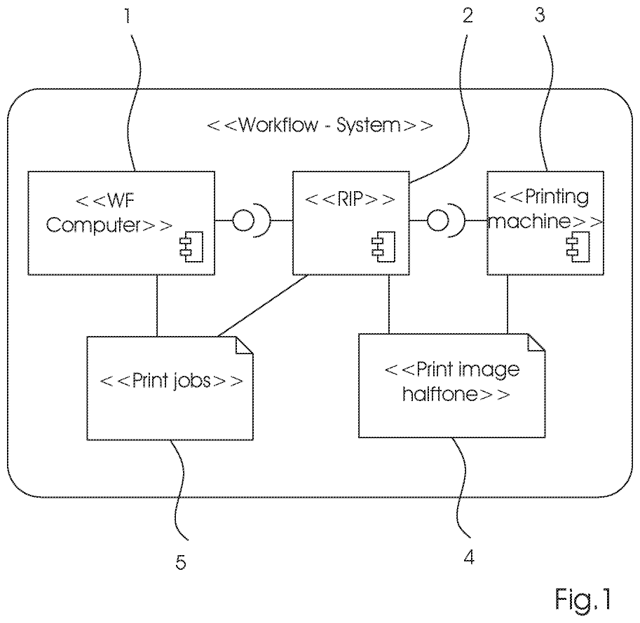

Referring now in detail to the figures of the drawings, in which mutually corresponding elements have the same reference symbols, and first, particularly, to FIG. 1 thereof, there is seen an inkjet printing machine 3 that is included in a specific workflow system and on which the method of the invention is implemented. An example of such a workflow system is shown by way of example in FIG. 1. The workflow system runs on one or more pre-print computers 1 for processing corresponding print jobs 5. A print job 5 to be printed on an inkjet printing machine 3 is submitted to a halftoning process by a raster image processor 2, which then forwards print image halftones 4 to the inkjet printing machine 3 for the corresponding print run. The raster image processor 2, which likewise runs on a computer 1 that may be identical with the pre-print computer of the workflow system, makes a calibration of the invention between gray values of the individual color separations of the pre-print image and corresponding halftone patterns 7 that form the print image halftone 4. In accordance with the invention, a compensation for local density fluctuations 8 that occur in the inkjet printing machine 3 is likewise carried out in the raster image processor 2.

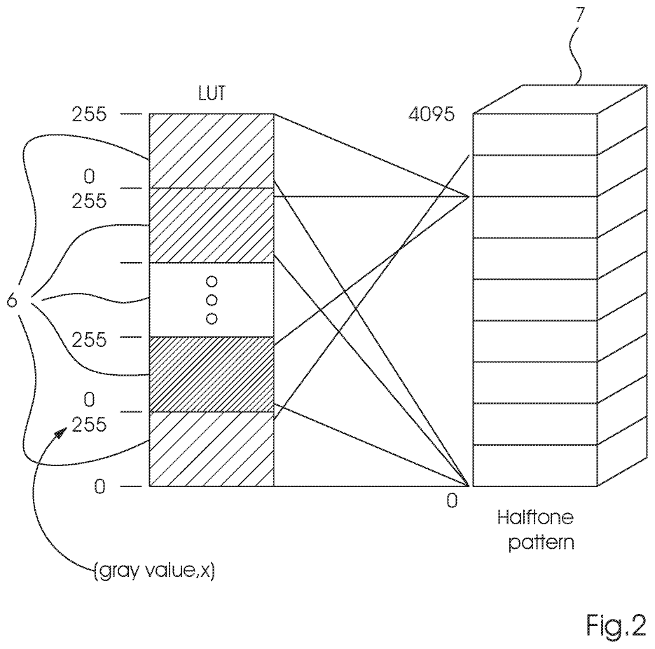

FIG. 2 illustrates how the calibration is adapted to compensate for density fluctuation. In this case, there is no longer just one look-up table (LUT) 6 containing gray values 0 to 255 and the specifically associated adapted halftone patterns 7. Instead, in addition to the gray value, the look-up table factors in the position of the respective printing nozzles based on the density profile that has been created to indicate the density fluctuations 8 in the inkjet printing machine 3. For a nozzle position X, for example, the set of gray values from 0 to 255 is assigned to a corresponding set of halftone patterns from 0 to 4095. For the next printing nozzle X+1, a further set of gray values 0 to 255 is assigned to the corresponding halftone patterns 7. For every printing nozzle that contributes to the print job 5 and therefore needs density fluctuation compensation, a corresponding set of gray value/halftone pattern 7 value pairs is created.

In a separate embodiment, it is possible to create the look-up table 6 that has been expanded to include additional position information on the respective printing nozzles even without the data of the current print job 5. The only thing that is required for density fluctuation compensation in accordance with the invention is the density profile that has been created and contains the local density fluctuations of the inkjet printing machine

Once the raster image processor 2 has been calibrated in accordance with the invention, the look-up tables 6 that have been created in this way to factor in the positions of the individual printing nozzles may be used in the halftoning process for the print job 5. As a consequence, the halftone image 4 that has been created based thereon already includes machine-specific density fluctuation compensation 8 for the inkjet printing machine 3 in question. Thus, the print image 4 that has been submitted to the halftoning process in this way may be printed with density compensation.

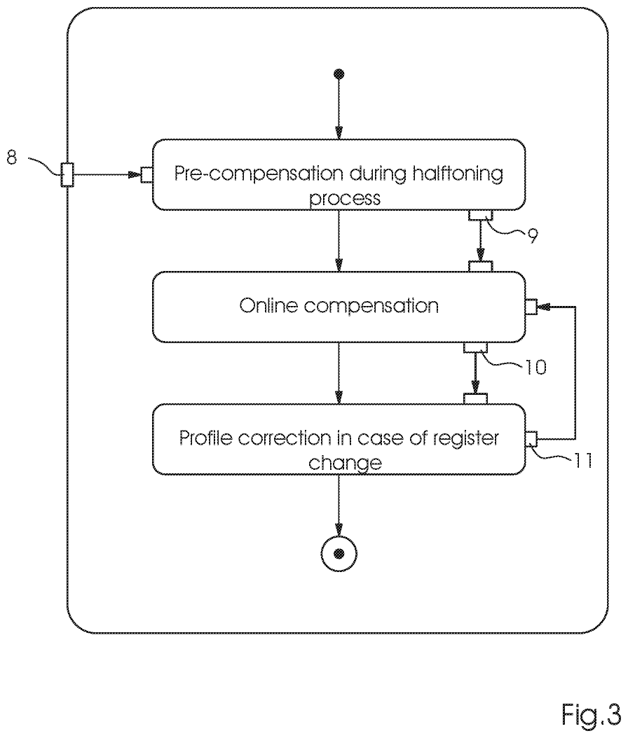

Now, in order to circumvent the disadvantages of the two known density compensation methods as described above and in order to make use of the advantages, a combination of the methods described above is proposed. FIG. 3 is a schematic flow chart of the method of the invention.

Step 1 is the pre-compensation process described above, implemented by the computer 1 in the color separations of the print image 8 of the current print job during the halftoning process on the basis of the compensation profile or on the basis of the density inhomogeneities known to exist in the heads and documented by the manufacturer of the head, and based on the settings of the piezoelectric voltages of the individual printing heads established in the rank calibration process. This step may be executed during the halftoning process using fixed profiles and settings. The modification frequency of these compensation profiles may be maintained on a low level. This step results in a pre-compensated print image halftone 9.

In step 2 the few remaining corrections are made in an online compensation process. This is generally done by the control unit of the inkjet printing machine 3. Due to the combination, the final result is a print image 10 that has additionally been subjected to online compensation and is position-independent. Modifications are covered by step 2. Due to the fact that only a few deviations remain, interference with the halftone is comparatively minor. Artifacts caused by major interference may thus be avoided. Since the total compensation is formed of two steps, two profiles need to be determined/defined. If a register change occurs in a direction transverse to the printing direction, the first profile will shift relative to the printing unit together with the print image 10. Consequently, the online compensation profile needs to be corrected in a corresponding way. The new second profile is created in the following way:

profile 2 new=profile 2−delta (profile 1−profile 1 shifted).

An application of the second profile results in an online-compensated print image 11 adjusted for register changes.

Logically, the density profile for calculating the compensation profile 2 needs to be determined by using the pre-compensation with the profile 1.

In a further preferred embodiment, the pre-compensation may correct the printing head-dependent inhomogeneities while the substrate-related influences are integrated in the online process. The method may further be configured in such a way that if different halftones are used, the influences of different halftones are integrated into the online process.

These measures may reduce the proportion of the inhomogeneities pre-compensated by the first density compensation process to a proportion of for instance 80% of the total error. Thus, the fundamental advantage remains.

The following is a summary list of reference numerals and the corresponding structure used in the above description of the invention:
1 pre-print department computer
2 raster image processor (RIP)
3 inkjet printing machine
4 halftone image
5 print job
6 matrix of position-dependent calibrated look-up tables (LuT)
7 halftone pattern
8 print image of the current print job
9 pre-compensated print image
10 online-compensated print image
11 online-compensated print image, adjusted for register change

1. A computer-assisted method for compensating for position-dependent density fluctuations in printing nozzles of inkjet printing heads in an inkjet printing machine, the method comprising the following steps:
carrying out a pre-compensation for all color separations of a print image during a halftoning process in a pre-print department based on a pre-defined density compensation profile by using a pre-print computer; and
carrying out an online compensation for all color separations of the pre-compensated print image during an on-going production run for producing a print image based on a newly calculated density compensation profile by using a control unit of the inkjet printing machine.

2. The method according to claim 1, which further comprises:
creating the pre-defined density compensation profile for the pre-compensation process based on at least one of a use of test measurements or density inhomongeneities having been documented by a printing head manufacturer; and
using the control unit of the inkjet printing machine to calculate the newly calculated density compensation profile for online compensation based on a comparison between existing target values and measured actual values of an area coverage of all color separations of the pre-compensated print image.

3. The method according to claim 1, which further comprises upon a register change in a direction transverse to the printing direction, using the control unit to correct the density compensation profile calculated by the control unit of the inkjet printing machine by subtracting a delta of the register change between the original predefined density compensation profile and the pre-defined density compensation profile having shifted due to the register change from the calculated density compensation profile.

4. The method according to claim 1, which further comprises using the pre-compensation process to mainly correct printing head-dependent density inhomogeneities and using the online compensation process to correct printing substrate influences.

5. The method according to claim 1, which further comprises using the control unit of the inkjet printing machine to factor in influences of different halftones in the pre-compensation process for the online compensation process.

6. The method according to claim 1, which further comprises:
during the pre-compensation process, in a course of a calibration of a raster image processor, using a look-up table to assign specific halftone patterns to specific gray values of the print image color separations intended to undergo the halftoning process;
providing the look-up table with a position of every printing nozzle of the printing heads of the inkjet printing machine as an additional variable;
for every position of a printing nozzle, using the pre-print computer to enter a complete set of gray values with associated adapted halftone patterns into the look-up table;
the pre-print computer using the halftone patterns in the print image halftoning process; and
using the inkjet printing machine to print the pre-compensated halftone print image.

7. The method according to claim 6, which further comprises providing an adapted assignment of halftone patterns to gray values as a function of the density fluctuation of the respective printing nozzle for every position of a printing nozzle in the look-up table.

8. The method according to claim 6, which further comprises implementing a maximum ink limit by using the pre-print computer to assign lower halftone patterns to higher gray values than it would in an equidistant normal distribution.

9. The method according to claim 1, which further comprises during the online compensation process, using the control unit:
to determine an actual area coverage for a location in a print to be compensated for based on the halftone by using a matrix,
to calculate the associated density compensation profile, and
to adapt the print image data to attain area coverage target values.

10. The method according to claim 9, which further comprises using the control unit to adapt the print image data by setting or eliminating pixels or by increasing or decreasing pixel sizes by controlling a jetted ink drop volume.

11. The method according to claim 1, which further comprises eliminating systematic density fluctuations occurring during the online compensation process in a following print job by carrying out the pre-compensation process.
